(19) United States
(12) Patent Application Publication
(10) Pub. No.: US 2006/0186323 A1
(43) Pub. Date: Aug. 24, 2006

(54) Highly reliable window and windshield fog-rain detector

(76) Inventors: Ying Chao Ruan, Raytown, MO (US); Jing Qing Tang, Raytown, MO (US)

Correspondence Address: Ying Chao Ruan, 558 Marble Arch Ave., San Jose, CA, 95136, US

(21) Appl. No.: 10/115,810

(22) Filed: Apr. 3, 2002

(51) Int. Cl. G02B 6/42

(52) U.S. Cl. 250/227.25

(57) ABSTRACT

A photo-electronic window and windshield fog-rain detecting system comprising two sub-systems from a film-attached fog detecting assembly, a regular detecting and a rain detecting assembly, and a corresponding Gate-relation circuits to couple the two assemblies with each other electronically to make multi function detecting. The regular detecting assembly uses an emitter to transmit light signals towards a test area on the windshield and uses a sensor to receive signals portion from the test area to sense the changes in the received signal portion, caused by fog or rain, so as to verify the existence of for or rain on the windshield. The film-attached assembly is formed by applying an appropriate opaque thin film material to the test area, such as foil, plastic, paint, etc., to avoid meeting any influence by the outside fog and rain, so as to be able to reliably detect fog on the interior surface of windshield and handle the defogger. The rain detecting assembly is formed by using a covering mounting structure to completely cover the detecting devices on the interior surface of windshield to avoid meeting any inside fog, so as to be able to reliably detect outside fog or rain on the exterior surface and handle the wipers. By coupling any two of three assemblies together electronically, a reliably multi function fog and rain detector is built up to instantly actuate a right tool, wipers or the vehicle defogger, to clear the windshield up when fog or rain is on.

### BACKGROUND

1. Field of the Invention

This invention is related to detectors, especially related to photo-electronic window and windshield fog-rain detectors.

2. Prior Art

There have been a lot of efforts to realize detecting fog and rain on the windshield by using photo-electronics in the past two decades, such as U.S. Pat. Nos. 4,620,141, 6,049,069, 6,162,410, etc. They use both an emitter to transmit light signals towards the windshield and a sensor to sense the reflected or refracted signals from it, so when fog or rain is on the windshield glass to change the intensities of the received signals, and so to be detected. In rain detectors, as described in U.S. Pat. No. 6,049,649, etc. all the emitter, its signal beam, the sensor, and their targeted surface area are generally covered together on the interior surface of the windshield to avoid meeting any inside fog in detecting. In fog detecting, U.S. Pat. No. 6,084,319 established a test area on the interior surface with no fog on it during driving by using a local cooler module, and used it to be a temperature reference to actuate the defogging system to prevent fog from formation on the whole interior surface. Both the test area and its neighboring area are monitored by two detectors, respectively. In the latest work, as described in U.S. Pat. No. 6,262,410, etc., both fog and rain are detected that not only they themselves, but also their host surface is detected as well. The inventions use an imaging sensor to receive the signals from windshield, and verify the host surface by comparing the received signals with the data stored in the circuits. The multi functions are carried on by rather complicated high performance photo-electronics. In the present paper patent application, the authors put forward a new simple fog detector, so called a film-attached detector, to reliably detect the fog on the interior surface of windshield, and further build multi function detectors by coupling it with a regular detecting system or a covered detecting system (a rain detecting system). The present invention also includes a fog-rain detector by coupling a regular system with a rain detecting system.

The film-attached detector is substantially made by applying appropriate opaque film material to the detected area, such as foil, some plastic or even a paint spot, etc. The film allows fog to form on it, but blocks the influence by the outside fog or rain. So the system can reliably to detect inside fog. By using a regular system to verify the existence of fog and rain and frost and using the above system or a rain-frost detecting system to further verify the host surface, the present invention successfully established a fog-rain detector, so as to be able to instantly actuate a right tool, wipers or defogger, to treat it.

### OBJECTS OF THE INVENTION

It is a general object of this invention to provide a highly effective window and windshield fog detector for detecting fog on the interior surface.

It is another object of this invention to provide a highly effective window and windshield multi function fog-rain detector.

Other objects will become more apparent as we present our application as follows.

### DESCRIPTION OF THE DRAWINGS

The present invention and its various objects and aspects may become more apparent from the following description of the preferred embodiments illustrated in accompanying drawings

FIG. 1 is a prospective front view of a detecting system of the present invention.

FIG. 2 is a prospective view of the present invention with an opened housing structure mounted on window glass.

FIG. 3 is a prospective front view of the present invention with its regular detecting sub-system covered on window glass.

FIG. 4A is a prospective over view of the covered sub-system of FIG. 3.

FIG. 4B is a section view of the system of FIG. 4A. FIG. 5 is a side vies of the present invention when installed on the rear mirror base.

The reference letters and numerals in the drawings:
1, 7, 47 are light emitters
2, 8 are the original signal light beams.
3 is a film.
4, 9 are test areas.
5, 10 are reflected light beams.
6, 11, 51 are sensors.
12 is refracted light.
13 is signal light.
14 is the signal beam passing through the window glass.
15 is the interior surface of window.
16 is the exterior surface of window.
17, 19 are processing circuits.
18 is a defogger.
20 is a wiper system.
21, 31, 41 are housing structure portions.
42 is refracted signal light.
43 is a rain drop.
44 is dispersed light.
50 is a coupling circuits.
55 is a side wall.
61 is a wiper.
62 is a vehicle windshield.
63 is the mounting base for holding the rear mirror of a vehicle.
64 is the present invention.
65 is a mounting device.
66 is the rear mirror.

### DETAILED DESCRIPTION OF THE INVENTION

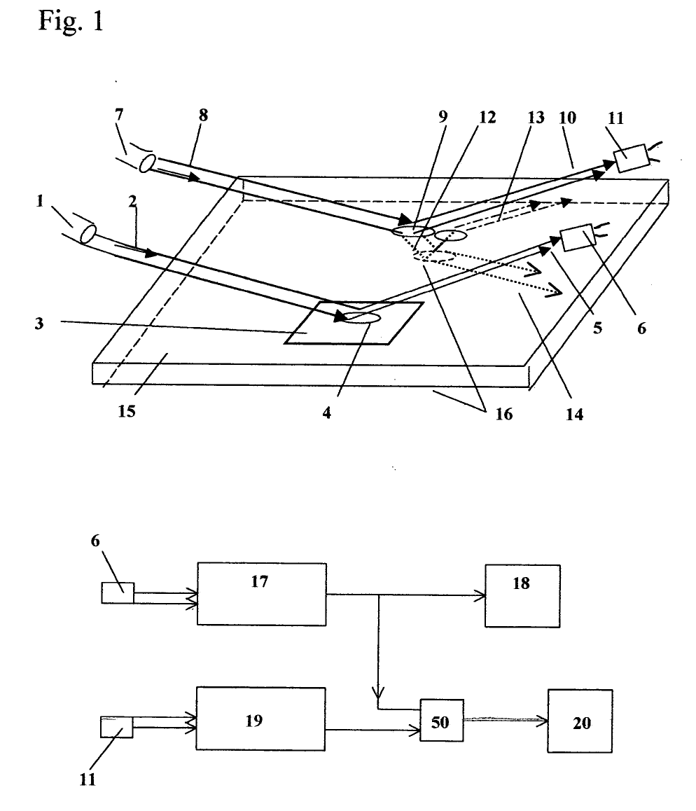

FIG. 1 shows a detecting system of the present invention installed in the vicinity of the interior surface 15 of the windshield. It has two sub-systems. One is called as a film-attached detecting assembly having an emitter 1 and a sensor 6 to target a test area 4 of 15, and a piece of film material 3 is applied to 4. 6 is further related to a processing circuits 17. 17 is related to the vehicle defogger 18. 3 is substantially opaque and allows fog to be formed on as the window glass does. The second sub-system is a regular optic detecting assembly with an emitter 7 and a sensor 11 to target a second test area 9 of 15. 11 is related to another processing circuits 19, connected to a wiper system 20. 20 is also related to 17 through a Gate-related circuits 50.

In the fist sub-system, emitter 1 transmits modulated light signal beams 2 towards 4. When beam 2 hits 3, it is reflected by 3 to create a reflected portion 5 to go to 6. When fog is formed on 15, including 3, it will disperse 2 at 3 and change the intensity of 5 and so to be sensed by 6. Sensor 6 will send a corresponding output to 17 to actuate 18 to work. Since 3 is opaque to 2, it prevents 2 from penetrating 3 and blocks any influence from outside, either. Thus, the above film-attached detecting is for only detecting interior fog. On the other hand, in the second sub-system, emitter 7 transmits signal beam 8 towards 9, and it is reflected by 9 to create a weak reflected portion 10 to go to 11. The refracted major portion 12 of 8 enters the glass with its major portion 14 penetrating the glass to travel away, leaving a weak light beam to be bounced back by 16 inside the glass and create a second beam 13 weaker than 5 to go to 7. This reflecting-refracting process will continue between 15 and 16 inside the glass, till the light travels away and eventually vanishes. When fog is formed on either 15 or 16, or when rain drops down to 16, it will disperse 2, 8 and 12, and change the received signals by 11, and so to be detected. Due to Gate circuits 50, only when 19 creates a high output while 17 sends a low output at the same time, corresponding to that there is fog on 16, wipers 20 is actuated to work.

Film 3 may also be applied on 16 from outside to prevent any fog or rain from touching 16. In this case, sensor 6 has no fog and rain to detect. The system is still a pure fog detector for 15.

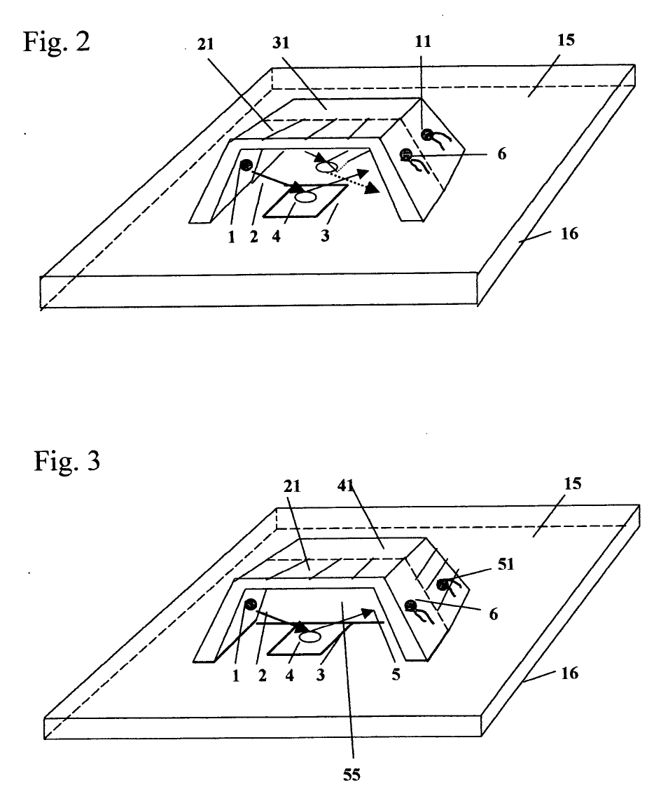

FIG. 2 shows a packaged system of FIG. 1. The whole system is held in a bridge-like housing structure having substantially two portions 21 and 31. 21 holds sensor 6 in one end supporting and holds 1 in the other one. (not shown in the figure) 31 holds the second sub-system in the similar way to the above.

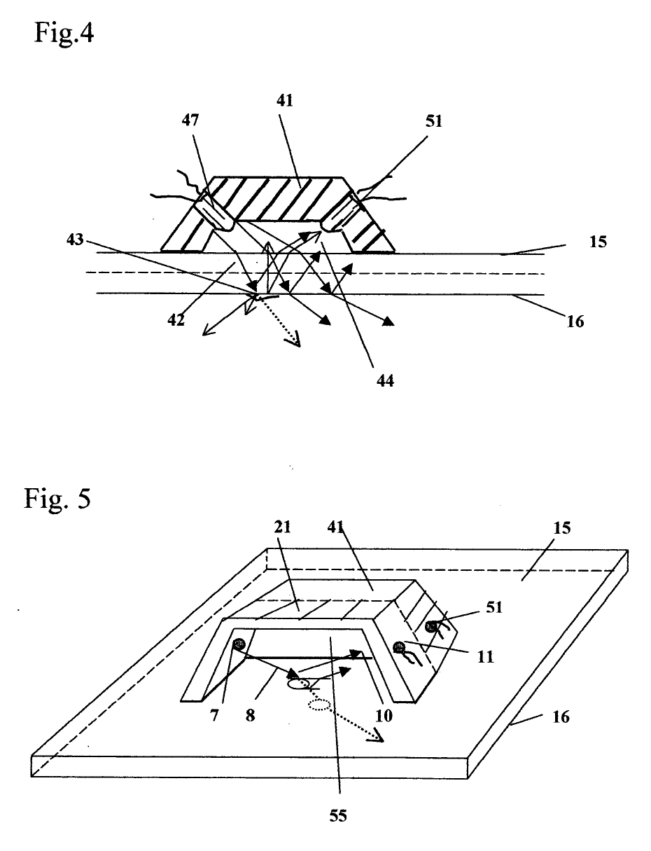

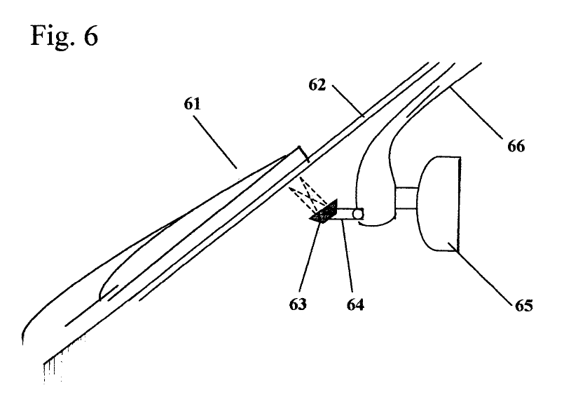

FIG. 3 shows another form of the present invention, held by a housing structure 21-41, with its half portion 41 to cover the second sub-system of FIG. 1. This covered sub-system turns to be a rain detector (See FIG. 4). The whole system is actually a combination of a fog detector and a rein detector.

FIG. 4 shows a section of the covered sub-system of FIG. 3. The housing portion 41 holds the subsystem system in it and installs the system on surface 15 to prevent the moisture inside the vehicle from entering it. In 41, the emitter, represented by 47, is held in one wall at a certain angle to transmit light signal towards the window glass. The Sensor, represented by 51, is held in the opposite wall towards the glass to receive the light signals Since no fog comes into 41 to be detected, the system only detect the outside rain and fog, it is a ‘rain detector’. If no fog is formed on the exterior surface 16 either, the major portion of the original signal light will penetrate the glass, leaving very little light to go to 51. If fog or rain drop 43 are in the detecting area on 16, it will produce dispersing 44 and enhance the received light by 51, and so to be sensed by 51.

If removing film 3 from the above system, we obtain another new fog-rain detector, as shown in FIG. 5, consisted of a rain detector and a regular sub-system. When the regular system senses the existence of fog or rain, the other will help verify the host surface.

FIG. 6 shows a mounting way of the present invention when mounted on the rear mirror base. 62 is the windshield glass. 65 is the rear mirror. 66 is the mirror mounting base. 63 is the present invention, held by mounting support 64 installed on 66 with the detecting head towards the windshield from inside in the wiping area of wipers 61.

It is understood that any changes in a film-attached fog detecting assembly, multi function fog-rain detectors, film materials, devices, number, covering structure, and mounting ways without changing the functions of the present invention will not depart from the scope and the spirit of the present invention.

We claim:

1. A window fog detecting system of having a ‘film-attached detecting’ assembly comprising
a window assembly having window glass with an interior surface and an exterior surface,
a defogger for vaporizing fog on said interior surface,
an optical detecting system for detecting fog on said interior surface,

2. Said fog detecting system of claim 1 wherein said optical detecting system comprises
a light signal source for transmitting predetermined modulated light signals towards a certain test area of said window glass,
an appropriate opaque film material, such as foil, plastic, paint, etc., applied to said test area to allow fog to form on it but prevent said detecting system from disturbing by outside fog,
a sensor device for receiving said light signals from said film and creating output, such that when fog is formed on said film to change the intensities of received signals by the sensor, said changes is sensed by the sensor and a corresponding output is created,
a processing circuits related to said sensor for processing said corresponding output from said sensor, caused by fog on said interior surface, to further create an operational output to actuate said defogger,
meanings for mounting said optical detecting system, comprising a mounting structure for holding both said source and said sensor properly towards said test area to make said source transmit light signals towards it and make said sensor effectively receive said signals from it to detect any changes in the intensities of said received signal light, caused by fog.

3. A window fog-rain detecting system comprising:
a vehicle windshield assembly having window glass with an interior surface and an exterior surface
a rear mirror held by a mounting base to place said mirror in the upper middle position in the vicinity of said windshield inside the vehicle,
a wiper system for sweeping said exterior surface,
a defogger for vaporizing fog on said interior surface,
an optical fog-rain detecting system for detecting fog and rain, and their host surface of said glass.
means for mounting said detecting system

4. Said fog-rain detecting system of claim 3 wherein said detecting system comprising:
a pair of two different assemblies from: a film-attached detecting assembly, a regular detecting assembly and a sealed regular detecting assembly.
a coupling circuits, corresponding to said pair.

5. Said fog-rain detecting system of claim 3 wherein said film-attached detecting assembly comprising: a light source for transmitting appropriate modulated light towards a test area on said windshield, an appropriate opaque film to be applied to a said test area to allow fog to form on it, a sensor device for receiving said light signals from said film and creating an output when detecting any changes in the intensities of its received light signals, caused by fog formed on said test area, and a processing circuits related to said sensor device for processing the said output signal to create an operational output to actuate said defogger.

6. Said fog-rain detecting system of claim 3 wherein said regular detecting assembly comprising: a light source for transmitting appropriate modulated light signals towards another test area on said windshield, another sensor device for receiving said light signals from said another test area and creating an output when sensing any changes in the intensities of its received signal light, caused by fog or rain on said another test area, and another processing circuits related to said another sensor device for processing said output and creating an operational output to create an operational output.

7. Said fog-rain detecting system of claim 3 wherein said covered regular detecting assembly, comprising: a related body part mounted in an appropriate mounting areas on said interior surface and isolated from the ambient inside the vehicle not to allow fog to form in it, a related light source held by said related body part properly for transmitting appropriate modulated light signals towards a related test area in said mounting area covered by said related body part, a related sensor device for receiving said signals from said related test area and creating an output when it detects any changes in the intensities of its received signals, caused by fog or rain on said exterior surface, and a related processing circuits related to said related sensor device for processing said output and creating an operational output to actuate said wiper system to work.

8. Said fog-rain detecting system of claim 3 wherein said coupling circuits comprising a Gate-related circuits for coupling the output of said processing circuits of claim 5 and the output of said processing circuits of claim 6, to actuate said wiper system to work when said fog-rain detecting system is consisted of said assembly of claim 5 and said assembly of claim 6 and only when said processing circuits of claim of 6 creates its operation output while said processing circuits of claim 5 sends no operational output at the same time; Or
said coupling circuits is another Gate-related circuits for coupling the output of said processing circuits of claim 6 and the output of said processing circuits of claim 7 to actuate said defogger to work, when said fog-rain detecting system is consisted of said assembly of claim 6 and said assembly of claim 7 and only when said processing circuits of claim 6 creates its operational output while said processing circuits of claim 7 sends no operational output at the same time; Or
said coupling circuits is Or-Gate related circuits for coupling the output of said processing circuits of claim 5 and the output of said processing circuits of claim 7 to actuate said defogger to work only if said processing circuits of claim 5 sends its operational output or to actuate said wiper system to work only if said processing circuits of claim 7 creates its operational output.

9. Said fog-rain detecting system of claim 3 wherein said means including bounding material for holding the two said body parts of the two assemblies of said fog-rain detecting system in a predetermined way and installing them in a certain area on said interior surface, or a mounting device for holding them together to mount on said rear mirror base to make it towards said windshield and target a position in the sweeping area of said wiper system.
